(19) United States
(12) Patent Application Publication
(10) Pub. No.: US 2024/0250872 A1
(43) Pub. Date: Jul. 25, 2024

(54) METHOD FOR CONTROLLING AND SWITCHING FIRMWARE

(71) Applicant: SAGEMCOM ENERGY & TELECOM SAS, Bois-Colombes (FR)

(72) Inventor: Henri TEBOULLE, Bois-Colombes (FR)

(73) Assignee: SAGEMCOM ENERGY & TELECOM SAS, Bois-Colombes (FR)

(21) Appl. No.: 18/415,241

(22) Filed: Jan. 17, 2024

(30) Foreign Application Priority Data
Jan. 25, 2023 (FR) 2300668

(51) Int. Cl. H04L 41/0813; H04L 7/00

(52) U.S. Cl. CPC H04L 41/0813; H04L 7/0033

(57) ABSTRACT

A method is proposed for controlling and switching a version of firmware for access to a communication network having a logical topology in the form of a tree of node devices implemented on an electrical supply network, the communication network includes a concentrator device. The method uses bit fields of the network management frames to automatically, redundantly and continuously check that a node device is using the same version of the communication protocol on the communication network as the concentrator device.

### TECHNICAL FIELD

The invention relates to the field of managing a version of firmware for access to a communication network having a logical topology in the form of a tree of node devices implemented on an electrical supply network.

### PRIOR ART

As is known, many communication networks have a topology (at least at the logic level) in tree form to make it possible to extend the range of the communications. The devices of such a communication network are generally called nodes. One node device holds the role of root of the communication network and manages the communication network so as to organise the sharing of one and the same communication support: transmission of beacons, topology management, etc. Node devices then serve as relays on behalf of other node devices of the communication network when they do not manage to directly receive information from the root node device (also called “base node”).

Such communication networks are in particular found in the context of electrical supply networks of the AMM (“automated meter management”) type, in which communications are established between so-called smart electricity meters and a data concentrator device, sometimes referred to as base node. This is the case for example in the PRIME (“PoweRline Intelligent Metering Evolution”) specifications. The concentrator device is then the root of the communication network. The exchanges between the electricity meters and the data concentrator device rely on powerline communications.

To make it possible to maintain the synchronisation of the node devices in the communication network, beacons are periodically transmitted. The beacons are transmitted during predefined time slots of each frame sent in the communication network.

One problem posed by this type of synchronisation mechanism by beacons is that sometimes a node device does not receive the beacon and does not synchronise.

Thus, in the case of an order to switch the network access firmware, it is possible that some node devices do not switch. In the absence of switching in the required time, the node devices ends up by no longer being able to communicate on the communication network.

In this context, it is necessary to provide a method for controlling and switching a version of the firmware for access to the communication network that can be executed automatically by a node device to regularly check that the node device is using the version of the access firmware that implements the version of the communication protocol used by the concentrator device on the communication network.

### DISCLOSURE OF THE INVENTION

For this purpose, according to a first aspect, a method is proposed for controlling and switching a version of firmware for access to a communication network that has a logical topology in the form of a tree of node devices and is implemented on an electrical supply network, the communication network comprising a concentrator device. The method is implemented by a node device comprising electronic circuitry and the method comprises a first phase comprising the following steps:
triggering a first time delay, and checking the reception, during the first time delay, of any frame making it possible to identify a version of the communication protocol used by the concentrator device;
if the version of the firmware used by the node device is implementing the version of the communication protocol used by the concentrator device, then reiterating the first phase, and otherwise triggering a second phase comprising the following steps:
triggering a second time delay, and checking the reception, during the second time delay, of network management frames of the “beacon” type sent by the concentrator device or by another node device, and/or of network management frames of the “promotion request” type sent by another node device, the network management frames making it possible to identify a version of the communication protocol used;
if a first predetermined number M of network management frames of the “beacon” type received and/or a second predetermined number N of network management frames of the “promotion request” type received make it possible to identify a version of the communication protocol used by the concentrator device or by another node device that is not implemented by the version of the firmware used by the node device, then switching the node device into another version of the firmware that implements the version of the communication protocol used by the concentrator device or by the relay device, and then reiterating the first phase;
if a number of network management frames of the “beacon” type received is strictly greater than zero and strictly smaller than the first predetermined number M and a number of network management frames of the “promotion request” type received is strictly greater than zero and strictly smaller than the second predetermined number N, then reiterating the second phase;
if no network management frame is received, then switching into another version of the firmware, and then reiterating the first phase.

Thus, particularly cleverly, the method according to the invention uses bit fields of the network management frames to automatically, redundantly and continuously check that a node device is using the same version of the communication protocol on the communication network as the concentrator device.

Thus the invention proposes a method for controlling and switching a version of the firmware for access to the communication network that can be executed automatically by a node device to regularly check that the node device is using a version of the access firmware that implements the version of the communication protocol used by the concentrator device on the communication network.

According to a particular provision, each network management frame comprises a bit field the value of which is predefined according to the version of the communication protocol used, so that the value of the bit field indicates the version of the communication protocol used by the concentrator device and/or another node device.

According to a particular provision, the network management frames received that are of the “beacon” type are predefined time slots of frames transmitted in the communication network and enable all the node devices to synchronise with the concentrator device.

According to a particular provision, the bit field is a result of a cyclic redundancy check the value of which indicates the version of the communication protocol used by the concentrator device and/or another node device.

According to a particular provision, the network management frames received that are of the “promotion request” type are predefined time slots of frames transmitted in the communication network and enable the concentrator device to change a node device to relay device.

According to a particular provision, the bit field is a most significant byte comprising four least significant bits, the four least significant bits being used to indicate the version of the communication protocol used by the concentrator device and/or another node device.

According to a particular provision, during the second phase, if no network management frame is received, then the node device switches into another version of the firmware that implements the version of the communication protocol used by the concentrator device, and then reiterates the first phase by reinitialising the first time delay according to a predetermined value.

According to a particular provision, the method comprises a prior step of initialising the first time delay and the second time delay, according to predetermined values.

According to a particular provision, the step consisting in checking the reception, during the second time delay, of network management frames is performed by checking the reception of network management frames sent by a plurality of devices of the communication network.

According to another aspect, a node device is proposed comprising electronic circuitry for executing the method according to the invention.

According to another aspect, a computer program product is proposed, comprising program code instructions for executing the method according to the invention, when said instructions are executed by a processor.

According to another aspect, a non-transient storage medium is proposed, on which a computer program is stored, comprising program code instructions for executing the method according to the invention, when said instructions are read from said non-transient storage medium and executed by a processor.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically a communication network the logical topology of which is in tree form, deployed on an electrical supply network and in which the invention can be implemented;

FIG. 2 illustrates schematically a method for controlling and switching a version of firmware for access to a communication network, according to the invention:

FIG. 3 illustrates schematically the structure of a network management frame of the “beacon” type sent using a first version of a communication protocol:

FIG. 4 illustrates schematically the structure of a network management frame of the “beacon” type sent using a second version of a communication protocol:

FIG. 5 illustrates schematically the structure of a network management frame of the “promotion request” type sent using a first version of a communication protocol:

FIG. 6 illustrates schematically the structure of a network management frame of the “promotion request” type sent using a second version of a communication protocol:

FIG. 7 illustrates schematically a hardware arrangement of a computer system that comprises electronic circuitry for implementing the method for controlling and switching a version of firmware for access to a communication network.

### DETAILED DISCLOSURE OF EMBODIMENTS

### Communication Network

The following description details the present invention in the context of a communication network the logical topology of which is in tree form, i.e. hierarchical from a root device, deployed on an electrical supply network, in order to implement AMM services. It should however be noted that the present invention applies to any communication network the logical topology of which is in tree form, i.e. hierarchical from a root device, in which devices act as relay devices for synchronisation by beacons to make it possible to establish communications between any device of the communication network and said root device.

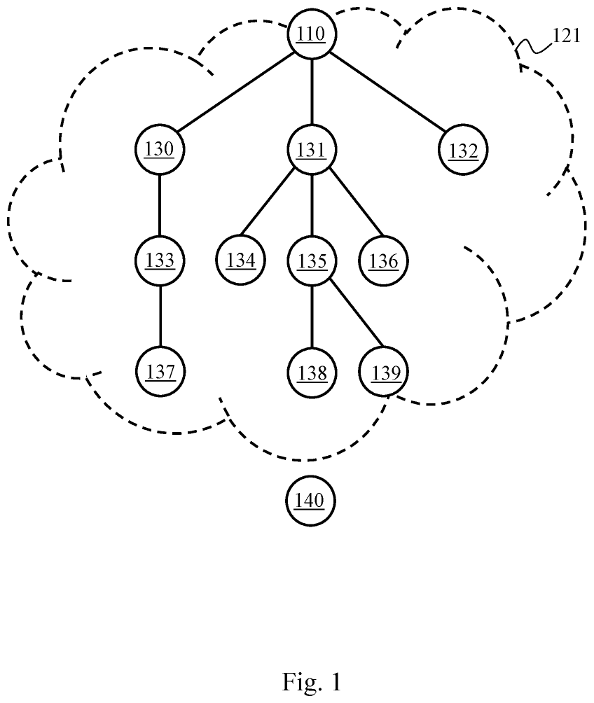

FIG. 1 illustrates schematically a communication network 121 having a logical topology in tree form, deployed on an electrical supply network and in which the invention can be implemented.

The communication network 121 is in tree form, a particular node device 110 of which, referred to as a concentrator device 110 or base node, is the root. The communication network 121 is intended to make it possible to connect a plurality of node devices to the concentrator device 110. In the context of FIG. 1, the node devices that the communication network 121 aims to connect are electricity meters. The communication network 121 thus makes it possible to establish powerline communications so that the concentrator device 110 can in particular automatically proceed with electricity consumption meter readings made by the electricity meters.

It is necessary to understand that, in such a communication network, a signal sent by a node device is in general not visible at every point of said communication network. Each node device sending signals then has a “neighbourhood domain”, i.e. a subset of said communication network in which any connected node device can receive said signals intelligibly. The neighbourhood domain corresponds to the range of the signals sent, according to predetermined transmission parameters (e.g. power, modulation and coding scheme, etc) of the node device sending the signal and also according to characteristics of the communication channel (attenuation, noise, impedance, etc). Each node device of said communication network thus has its own neighbourhood domain.

To make it possible to extend the range of powerline communications, node devices fulfil the role of data relays between other node devices and the concentrator device 110. Such a relay device is called a switch in the PRIME specifications. Some communications between node devices and the concentrator device 110 may require several successive data relays. A node device not fulfilling the role of relay is called an end device. Such a structure therefore defines attachments of node devices to each other to form the tree, i.e. the hierarchy constituting the communication network 121. Each node device of the communication network 121 is thus associated with a hierarchical level, typically corresponding to the quantity of relay devices via which said node device must pass to reach the root of the communication network 121.

Apart from relaying data, the relay devices send beacons 300, which enable the node devices 130-139 that are attached to them to synchronise with the communication network 121. These beacons are sent in predefined respective time slots. The structure of these beacons 300 will be defined hereinafter.

Such a communication network in tree form is therefore shown on FIG. 1. An end node device 132 is directly attached to the concentrator device 110. Two other node devices 130 and 131 are also directly attached to the concentrator device 110. These two node devices 130 and 131 fulfil the role of relay devices between the concentrator device 110 and other node devices. The node device 130 fulfils the role of a relay device between the concentrator device 110 and a node device 133 which, itself, fulfils the role of relay device between the node device 130 and an end device 137. The communications between the concentrator device 110 and the end device 137 therefore pass through two successive relay devices, namely the relay devices 130 and 133. The node device 131 fulfils the role of relay device between the concentrator device 110 and three other node devices 134, 135 and 136. The node devices 134 and 136 are end devices, and the node device 135 fulfils the role of relay device between the node device 131 and two end devices 138 and 139. Thus the node devices 130, 131 and 132 are associated with a hierarchical level of value “0”, the node devices 133, 134, 135, 136 are associated with a hierarchical level of value “1”, and so on.

A node device that is not attached to the communication network 121 is a disconnected device, such as the node device 140 on FIG. 1.

It must be understood that the logical topology of the communication network 121 is not fixed. FIG. 1 shows the logical topology of the communication network 121 at a given instant. Because in particular of interference phenomena (such as noise, attenuation, variation in impedance, crosstalk, signal collision, etc), node devices may be disconnected from the communication network 121 and then seek to reregister in the communication network 121. The logical topology of the communication network 121 at that moment is then probably different from the logical topology of the communication network 121 before said node devices were disconnected, some node devices then having potentially been deprived of their relay role and others then having potentially been promised to fulfil the role of relay. A node device 130-139 is promoted into a relay device by the sending of a promotion request 400 (Promotion Needed Protocol Data Unit, abbreviated to PNPDU) from a node device that is seeking to connect to the communication network 121 and does not have a relay device as a neighbour, such as the node device 140, to the node device 130-139 to be promoted into a relay device. The structure of a promotion request 400 will be detailed hereinafter.

Moreover, the concentrator device 110 uses a version of a communication protocol for transmitting information to all the node devices 130-139 of the communication network 121. When the concentrator device 110 changes version of the communication protocol, it sends an instruction to switch network-access firmware to all the node devices 130-139. The node devices 130-139 then switch into another version of the firmware that makes it possible to implement the new version of the communication protocol used by the concentrator device 110. However, it may happen that a node device 130-139 does not receive the switching instruction and remains with an old version of the firmware. The node device then risks no longer receiving the frames sent by the concentrator device and being disconnected from the communication network. To avoid this problem, the control and switching method detailed below is proposed.

### Control and Switching Method

With reference to FIG. 1, according to a first aspect, a method 1 is proposed for controlling and switching a version of firmware for access to the communication network 121.

The method is implemented by each node device 130-140 of the communication network 121. Thus each node device 130-140 comprises electronic circuitry 200 enabling it to implement the method 1.

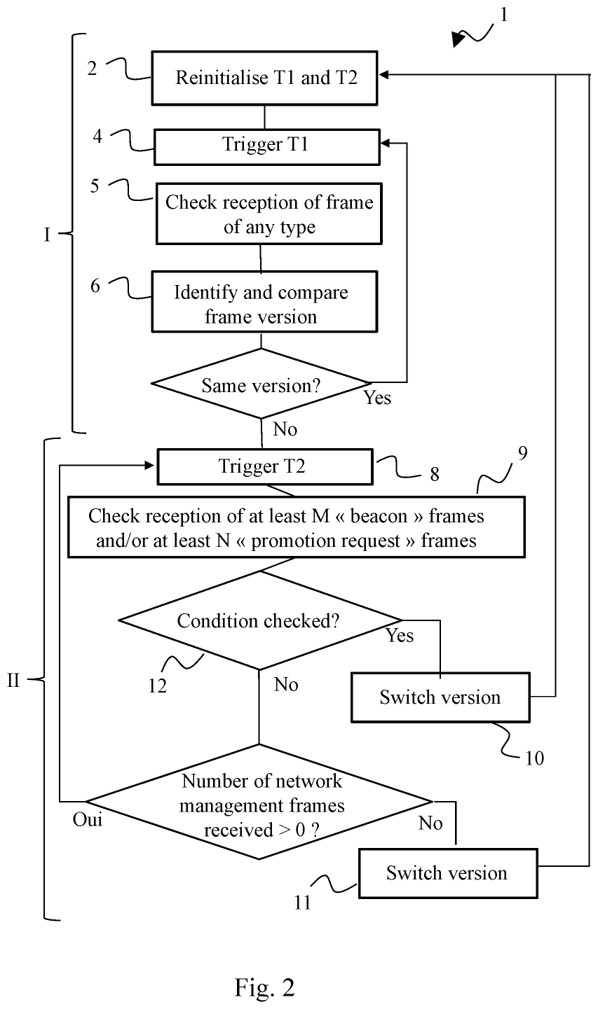

As shown schematically on FIG. 2, the method 1 comprises mainly a first phase I and a second phase II.

### First Phase I

In the first phase I, the method 1 comprises a step 4 consisting in triggering a first time delay. Then the method 1 comprises a step 5 consisting in checking, during the first time delay T1, the reception of a frame of any type sent by the concentrator device 110 and/or another node device (130-140) acting as a relay device or as an end device. The frame of any type making it possible to identify a version of the communication protocol used by the concentrator device 110. Thus, in other words, according to step 5, the node device 130-140 listens to the communication network 121 and receives a frame of any type sent by the concentrator device 110 and/or another node device (130-140) acting as a relay device or as an end device. As will be detailed below, for the particular case of the beacons 300 and promotion requests 400, the structure of each frame makes it possible to identify the version of the communication protocol used by the concentrator device 110 on the communication network 121. Thus each frame sent by the concentrator device 110 (or by a node device (130-140) acting as a relay device or as an end device) comprises information making it possible to identify the version of the communication protocol used by the concentrator device 110 (or by a node device (130-140) acting as a relay device or as an end device).

When a frame of any type is received, the method 1 comprises a step 6, in which the node device 130-140 identifies the version of the communication protocol used by the concentrator device 110 and compares a version of the firmware used by the node device 130-140 and the version of the communication protocol used by the concentrator device 110. The comparison consists in determining whether the version of the firmware used by the node device 130-1140 implements or not the version of the communication protocol used by the concentrator device 110.

Thus, in other words, the comparison of the step 6 can consist, for the node device 130-140, in determining whether it can read the frame, or not. If the node device 130-140 can read the frame of any type, then it uses the version of the firmware that implements the version of the communication protocol used by the concentrator device 110. On the other hand, if it appears that the frame cannot be read by the node device 130-140, then it is that the node device 130-140 is using a version of the firmware that does not implement the version of the communication protocol used by the concentrator device 110.

If the version of the firmware used by the node device 130-140 implements the version of the communication protocol used by the concentrator device 110, then the node device 130-140 reiterates the first phase I.

### Second Phase II

If the version of the firmware used by the node device 130-140 does not implement the version of the communication protocol used by the concentrator device 110, then the node device 130-140 triggers the second phase II of the method 1.

The second phase II comprises a step 8 that consists in triggering a second time delay T2. Then the second phase II comprises a step 9 that consists in checking, during the second time delay T2, the reception of network management frames sent by the concentrator device 110 or by another node device 130-140 acting as a relay device between the concentrator device 110 and the node device 130-140 or by another node device 130-140 acting as end device.

The network management frames make it possible to identify a version of the communication protocol used by the concentrator device 110 or by another node device (130-140) acting as a relay device or as an end device. In other words, according to the step 8, if it appears that the firmware used by the node device 130-139 does not implement the version of the communication protocol used by the concentrator device 110, then the node device 130-139 listens precisely to the network management frames sent by the concentrator device 110 or another node device 130-140. As will be detailed below, according to a particularly advantageous technical arrangement of the invention, analysing certain bit fields in the structure of the network management frames makes it possible to know precisely the version of the communication protocol used.

It is stated that, according to a particular provision, at the step 8, the node device 130-140 checks the reception of management frames sent by a plurality of devices connected to the communication network 121. In other words, according to this provision, the node device 130-140 listens to the network management frames sent from a plurality of different sources.

If (condition 12) the node device captures a first predetermined number M of network management frames of the “beacon” type and/or a second predetermined number N of network management frames of the “promotion request” type, which each indicate a version of the communication protocol that is not implemented by the version of the firmware used by the node device 130-140, then the method 1 comprises a step 10 consisting in switching the node device 130-140 into another version of the firmware that implements the version of the communication protocol used by the concentrator device 110 and/or another node device 130-140. Then the node device 130-140 reiterates the first phase I of the method 1.

According to a particularly advantageous provision, the node device 130-140 reiterates the first phase I of the method while re-initialising the first time delay T1 (step 2). Typically, the first time delay T1 can be re-initialised to have a duration of 6 hours.

Analysing a first predetermined number M of management frames of the “beacon” type 300 and a second predetermined number N of management frames of the “promotion request” type 400 received over the second time delay T2 is a particularly advantageous technical provision of the invention. This is because this provision makes it possible to ensure that the majority of the network management frames received during the second time delay T2 do indeed indicate one and the same communication protocol version used by the concentrator device 110 and/or another node device 130-140. In other words, this provision makes it possible to avoid an isolated error in the sending of a network management frame triggering a change of version of the firmware by the node device 130-140.

Typically, the first predetermined number M can be a positive integer between 5 and 11 and more particularly between 7 and 9 inclusive, and the second predetermined number N can be a positive integer between 4 and 9 and more particularly between 5 and 7. If a number of network management frames received of the “beacon” type 300 is strictly greater than zero but strictly smaller than the first predetermined number M and a number of network management frames received of the “promotion request” type 400 is strictly greater than zero but strictly less than the second predetermined number N, then the node device 130-140 reiterates the second phase II of the method 1.

If no network management frame is received, then the method 1 comprises a step 11 that consists in switching into another version of the firmware. Then the method 1 reiterates the first phase I of the method while re-initialising the first time delay T1. Typically, the first time delay T1 can be re-initialised to have a duration of one hour. In other words, the step 11 is performed if the node device 130-139 does not receive any network management frame. In this case, and according to the operating principle of the PRIME communication network that was disclosed above, it is probable that the node device 130-140 has been disconnected from the communication network. Consequently, the node device 130-139 changes firmware version in order to be reconnected to the communication network 121.

Then the node device 130-140 reiterates the phase I while reinitialising the first time delay T1 over a short duration. Thus this makes it possible to quickly detect an error. This is because the change of firmware version must make it possible to reconnect the node device 130-140 to the communication network 121, so that the node device 130-139 will necessarily receive at least one frame of any type during the first time delay T1.

### Initialisation of the Time Delay Durations

Particularly advantageously, the method I can comprise a prior step 2 of initialising each time delay T1 and T2.

According to a particular embodiment, the first time delay T1 can for example be defined as being equal to 6 hours.

According to a particular embodiment, the second time delay T2 can for example be defined as being equal to 1 hour.

The network management frames received and used are preferentially of the “beacon” type 300 or of the “promotion request” type 400, as described previously.

The method 1 according to the invention uses a particular knowledge of the structures of the network management frames of the “beacon” type 300 and of the “promotion request” type 400, to determine the version of the communication protocol used to send the network management frames of the “beacon” type 300 and of the “promotion request” type 400.

### Structure of the Beacons

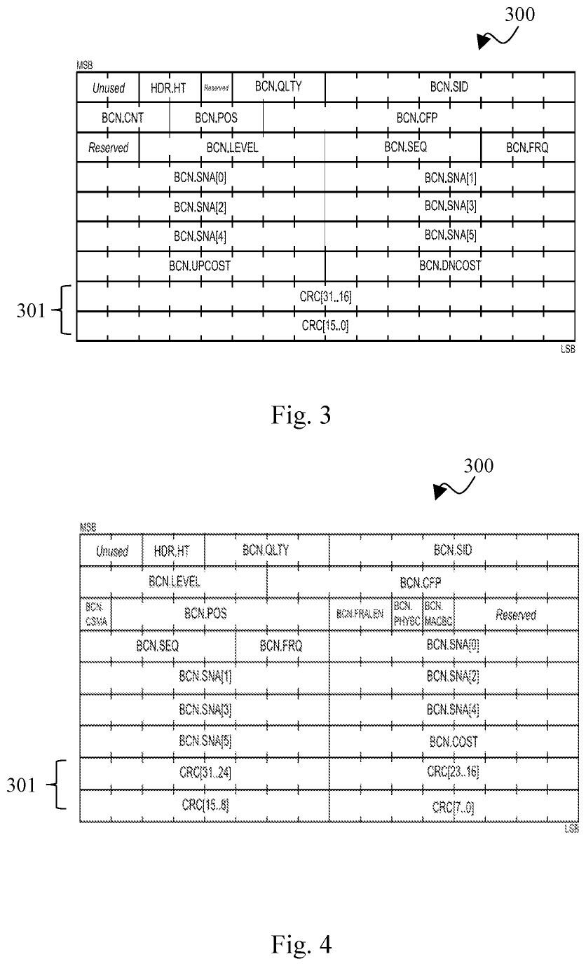

FIG. 3 illustrates schematically the structure of a network management frame of the “beacon” type 300 sent using a first version of the communication protocol over the communication network 121.

FIG. 4 illustrates schematically the structure of a network management frame of the “beacon” type 300 sent using a second version of the communication protocol over the communication network 121.

Whatever the version of the communication protocol used, each network management frame of the “beacon” type 300 has a bit field 301 that is a result of a cyclic redundancy check CRC the value of which indicates the version of the communication protocol used by the concentrator device 110 and/or the relay device.

This is because it is observed that each network management frame of the “beacon” type 300 comprises a payload. Whatever the version of the communication protocol used, the payloads have the same number of bytes. On the other hand, the payloads differ with regard to the location and/or the number of bits of the following fields: BCN.LEVEL, BCN.POS, BCN.COST, BCN.SEQ and BCN.FRQ. These differences cause differences with regard to the result of the cyclic redundancy check CRC.

Furthermore, it is also observed that, according to a first version of the communication protocol, the result of the cyclic redundancy check CRC is determined using the whole of the structure of the network management frame of the “beacon” type 300, with the exception of the result of the cyclic redundancy check CRC itself.

On the other hand, according to a second version of the communication protocol, the result of the cyclic redundancy check CRC is determined using the whole of the structure of the network management frame of the “beacon” type 300, including the result of the cyclic redundancy check CRC itself, to which a default value for this determination is allocated.

Thus, for the network management frames of the “beacon” type 300, the result of the cyclic redundancy check CRC is identical if the network management frames of the “beacon” type 300 are sent using the same version of the communication protocol and the result of the cyclic redundancy check CRC differs if the network management frames of the “beacon” type 300 are sent using two different versions of the communication protocol.

### Structure of the Promotion Requests

FIG. 5 illustrates schematically the structure of a network management frame of the “promotion request” type 400 sent using a first version of the communication protocol over the communication network 121.

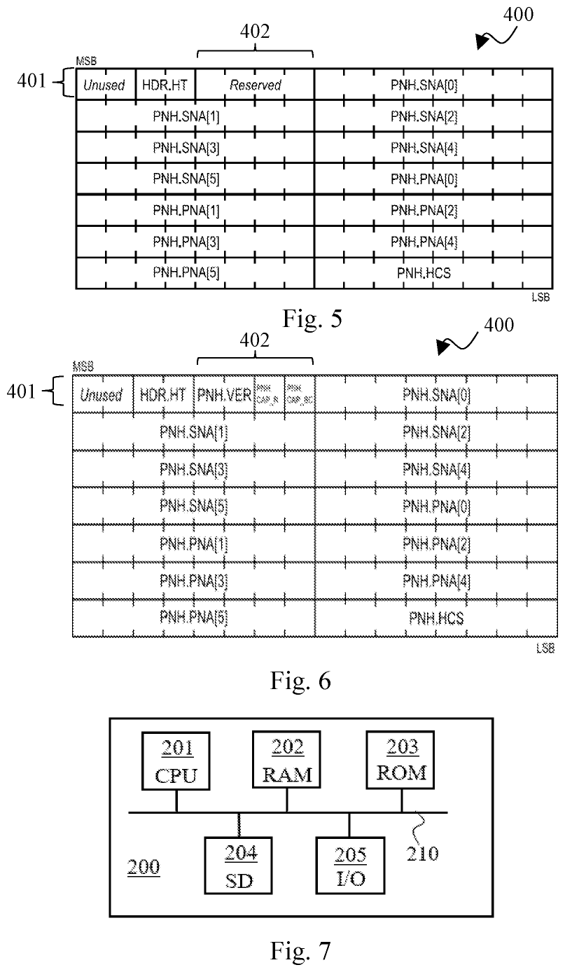

FIG. 6 illustrates schematically the structure of a network management frame of the “promotion request” type 400 sent using a second version of the communication protocol over the communication network 121.

Whatever the version of the communication protocol used, each network management frame of the “promotion request” type 400 has a bit field 401 that is a most significant byte MSB comprising four least significant bits 402, the four least significant bits 402 being used to indicate the version of the communication protocol used by the concentrator device and/or another node device (130-139) acting as a relay device or acting as an end device.

More precisely, the four least significant bits are said to be reserved. Thus it is possible to use two bits out of these four bits to distinguish two versions of the communication protocol. According to a particular provision, the two bits used are the PNH. VER bits. Thus, according to a first version of the communication protocol, the two PNH. VER bits can be equal to 00 and according to a second version the two PNH. VER bits can be equal to 01.

### Node Device

According to another aspect, a node device 130-139 is proposed comprising electronic circuitry 200 for executing the method 1.

### Computer System

According to another aspect, a computer system 200 is proposed comprising electronic circuitry configured to implement a method 100 for controlling and switching a version of firmware for access to a communication network.

As shown schematically on FIG. 7, the computer system 200 can comprise, connected by a communication bus 210: a processor 201: a random access memory 202; a read only memory 203, for example of the ROM or EEPROM (“electrically-erasable programmable read-only memory”) type: a storage unit 204, such as a hard disk drive HDD or a storage medium reader, such as an SD (Secure Digital) card reader: and an input-output interface manager 205.

The processor 201 is capable of executing instructions loaded in the random access memory 202 from the read-only memory 203, from an external memory, from a storage medium (such as an SD card), or from a communication network. When the computer system 200 is powered up, the processor 201 is capable of reading instructions from the random access memory 202 and executing them. These instructions form a computer program causing the implementation, by the processor 201, of the method and steps described here.

All or some of the method and steps described above can thus be implemented in software form by executing a set of instructions by a programmable machine, for example a processor of the DSP (“digital signal processor”) type, or a microcontroller, or be implemented in hardware form by a machine or a dedicated component, for example an FPGA (field-programmable gate array) or an ASIC (application-specific integrated circuit) component. In general terms, the computer system 200 comprises electronic circuitry adapted and configured to implement, in software and/or hardware form, the method and steps described above in relation to the computer system 200 in question.

1. A method for controlling and switching a version of firmware for access to a communication network that has a logical topology in the form of a tree of node devices and is implemented on an electrical supply network, the communication network comprising a concentrator device, the method being implemented by a node device comprising electronic circuitry and the method comprising a first phase comprising the following steps:
triggering a first time delay and checking the reception, during the first time delay, of a frame of any type making it possible to identify a version of the communication protocol used by the concentrator device;
if the version of the firmware used by the node device is implementing the version of the communication protocol used by the concentrator device, then reiterating the first phase, and otherwise triggering a second phase comprising the following steps:
triggering a second time delay, and checking the reception, during the second time delay, of network management frames of the “beacon” type sent by the concentrator device or by another node device, and/or of network management frames of the “promotion request” type sent by another node device, the network management frames making it possible to identify a version of the communication protocol used;
if a first predetermined number M of network management frames of the “beacon” type received and/or a second predetermined number N of network management frames of the “promotion request” type received make it possible to identify a version of the communication protocol used by the concentrator device or by another node device that is not implemented by the version of the firmware used by the node device, then switching the node device into another version of the firmware that implements the version of the communication protocol used by the concentrator device or by the relay device, and then reiterating the first phase;
if a number of network management frames of the “beacon” type received is strictly greater than zero and strictly smaller than the first predetermined number M and a number of network management frames of the “promotion request” type received is strictly greater than zero and strictly smaller than the second predetermined number N, then reiterating the second phase;
if no network management frame is received, then switching into another version of the firmware, and then reiterating the first phase.

2. The method according to claim 1, wherein each network management frame comprises a bit field the value of which is predefined according to the version of the communication protocol used, so that the value of the bit field indicates the version of the communication protocol used by the concentrator device and/or another node device.

3. The method according to claim 1, wherein the network management frames received that are of the “beacon” type are predefined time slots of frames transmitted in the communication network and enable all the node devices to synchronise with the concentrator device.

4. The method according to claim 3, wherein the bit field is a result of a cyclic redundancy check the value of which indicates the version of the communication protocol used by the concentrator device and/or another node device.

5. The method according to claim 1, wherein the network management frames received that are of the “promotion request” type are predefined time slots of frames transmitted in the communication network and enable the concentrator device to change a node device into a relay device.

6. The method according to claim 5, wherein the bit field is a most significant byte comprising four least significant bits, the four least significant bits being used to indicate the version of the communication protocol used by the concentrator device and/or another node device.

7. The method according to claim 1, wherein, during the second phase, if no network management frame is received, then the node device switches into another version of the firmware that implements the version of the communication protocol used by the concentrator device, and then reiterates the first phasewhile reinitialising the first time delay according to a predetermined value.

8. The method according to claim 1, comprising a prior step of initialising the first time delay and the second time delay, according to predetermined values.

9. The method according to claim 1, wherein the step consisting in checking the reception, during the second time delay, of network management frames is performed by checking the reception of network management frames sent by a plurality of devices of the communication network.

10. A node device comprising electronic circuitry for executing the method according to claim 1.

11. A computer program product comprising program code instructions for executing the method according to claim 1, when said instructions are executed by at least one processor.

12. A non-transient storage medium on which a computer program product is stored, comprising program code instructions for executing the method according to claim 1, when said instructions are read from said non-transient storage medium and executed by a processor.
